(19) United States
(12) Patent Application Publication
(10) Pub. No.: US 2014/0120930 A1
(43) Pub. Date: May 1, 2014

(54) Method, Apparatus, Computer Program Product and System for Communicating Predictions

(71) Applicant: NOKIA SIEMENS NETWORKS OY, Espoo (FI)

(72) Inventors: John HARRIS, Glenview, IL (US); Anatoly ANDRIANOV, Schaumburg, IL (US)

(73) Assignee: NOKIA SIEMENS NETWORKS OY, Espoo (FI)

(21) Appl. No.: 13/665,393

(22) Filed: Oct. 31, 2012

(51) Int. Cl. H04W 24/02

(52) U.S. Cl. CPC H04W 24/02
USPC 455/452.1; 455/422.1

(57) ABSTRACT

Various communication systems may benefit from communication of (key) performance indicators ((K)PIs). For example, a third generation partnership project (3GPP) long term evolution (LTE) operation and maintenance (O&M) system may benefit from predictive (key) performance indicator reporting between a base station, such as an evolved Node B (eNB), and the O&M system. A method may comprise generating at least one of a predicted (key) performance indicator or a (key) performance indicator trend information at a first network element. The method may also comprise sending the at least one of predicted (key) performance indicator or (key) performance indicator trend information from the first network element to the second network element.

### BACKGROUND

1. Field

Various communication systems may benefit from communication of performance indicators such as, for example, key performance indicators (KPIs). For example, a third generation partnership project (3GPP) long term evolution (LTE) operation and maintenance (O&M) system may benefit from key performance indicator reporting between a base station, such as an evolved Node B (eNB), and the O&M system.

2. Description of the Related Art

Currently O&M metrics are all historical. Namely, these metrics report on past events. Moreover, a centralized system may conventionally gather data and perform predictions. Indeed, some conventional approaches may include predictions based on gathered data such as providing likelihood of a user equipment (UE) encountering a coverage hole to an application impacting network elements like a media optimizer.

### SUMMARY

According to a first embodiment, a method may comprise generating at least one of a predicted performance indicator or a performance indicator trend information at a first network element. The method may also comprise sending the at least one of predicted performance indicator or performance indicator trend information from the first network element to the second network element.

In a variation, one of the first network element and the second network element may comprise an operation and maintenance system.

In a variation, the operation and maintenance system may comprise a self-organizing network (SON) server.

In a variation, one of the first network element and the second network element may comprise a radio access network element.

In a variation, one of the first network element and the second network element may comprise a core network element.

In a variation, the method may further comprise sending a confidence metric with the at least one of predicted performance indicator or performance indicator trend information.

In a variation, the confidence metric may comprise at least one of a numeric value or a percentile range of performance indicator.

In a variation, the method may further compromise selecting a time interval for the performance indicator trend information based on a time between explicit performance indicator reports.

In a variation, the predicted performance indicator may be a predicted key performance indicator, and the performance indicator trend information may be a key performance indicator trend information.

In a variation, the predicted performance indicator may be a performance measurement or performance counter and the performance indicator trend information may be a performance measurement trend information or performance counter trend information.

The above variations may be combined with one another or taken individually.

According to a second embodiment, a method may comprise receiving at least one of a predicted performance indicator or a performance indicator trend information at a second network element from a first network element. The method may also comprise performing, at the second network element, at least one network procedure based on the received at least one of predicted performance indicator or performance indicator trend information.

In a variation, one of the first network element and the second network element may comprise an operation and maintenance system.

In a variation, the operation and maintenance system may comprise a self-organizing network (SON) server.

In a variation, one of the first network element and the second network element may comprise a radio access network element.

In a variation, one of the first network element and the second network element may comprise a core network element.

In a variation, the method may comprise receiving a confidence metric with the at least one of predicted performance indicator or performance indicator trend information.

In a variation, the confidence metric may comprise at least one of a numeric value or a percentile range of performance indicator.

In a variation, the method may further comprise determining whether to increase or decrease loading based on the received at least one of predicted performance indicator or performance indicator trend information.

In a variation, the at least one network procedure may comprise a base station (for example an eNode B) performing at least one of blocking more new calls when additional loading from neighboring cells may be anticipated; reactivating more small cells, which were previously deactivated; or initiating more customer/application techniques suggesting greater application usage in regions based on regional performance indicators.

In a variation, the at least one network procedure may comprise an operation and maintenance system performing at least one of reactivating more small cells, which were previously deactivated; triggering server based application optimization techniques to increase or decrease loading; or initiating more customer/application techniques suggesting greater application usage in regions based on regional performance indicators.

In a variation, the predicted performance indicator may be a predicted key performance indicator and the performance indicator trend information may be a key performance indicator trend information.

The above variations may be combined with one another or taken individually.

According to a third embodiment, an apparatus may comprise at least one processor and at least one memory including computer program code. The at least one memory and the computer program code may be configured to, with the at least one processor, cause the apparatus at least to generate at least one of a predicted performance indicator or a performance indicator trend information at a first network element. The at least one memory and the computer program code may also be configured to, with the at least one processor, cause the apparatus at least to send the at least one of predicted performance indicator or performance indicator trend information from the first network element to the second network element.

In a variation, one of the first network element and the second network element may comprise an operation and maintenance system.

In a variation, the operation and maintenance system may comprise a self-organizing network (SON) server.

In a variation, one of the first network element and the second network element may comprise a radio access network element.

In a variation, one of the first network element and the second network element may comprise a core network element.

In a variation, the at least one memory and the computer program code are further configured to, with the at least one processor, cause the apparatus at least to send a confidence metric with the at least one of predicted performance indicator or performance indicator trend information.

In a variation, the confidence metric may comprise at least one of a numeric value or a percentile range of performance indicator.

In a variation, the at least one memory and the computer program code may be configured to, with the at least one processor, cause the apparatus at least to select a time interval for the performance indicator trend information based on a time between explicit performance indicator reports.

In a variation, the predicted performance indicator may be a predicted key performance indicator and the performance indicator trend information may be a key performance indicator trend information.

In a variation, the predicted performance indicator may be a performance measurement or performance counter and the performance indicator trend information may be a performance measurement trend information or performance counter trend information.

The above variations may be combined with one another or taken individually.

According to a fourth embodiment, an apparatus may comprise at least one processor and at least one memory including computer program code. The at least one memory and the computer program code may be configured to, with the at least one processor, cause the apparatus at least to receive at least one of a predicted performance indicator or a performance indicator trend information at a second network element from a first network element. The at least one memory and the computer program code may also be configured to, with the at least one processor, cause the apparatus at least to perform, at the second network element, at least one network procedure based on the received at least one of predicted performance indicator or performance indicator trend information.

In a variation, one of the first network element and the second network element may comprise an operation and maintenance system.

In a variation, the operation and maintenance system may comprise a self-organizing network (SON) server.

In a variation, one of the first network element and the second network element may comprise a radio access network element.

In a variation, one of the first network element and the second network element may comprise a core network element.

In a variation, the at least one memory and the computer program code may be configured to, with the at least one processor, cause the apparatus at least to receive a confidence metric with the at least one of predicted performance indicator or performance indicator trend information.

In a variation, the confidence metric may comprise at least one of a numeric value or a percentile range of performance indicator.

In a variation, the at least one memory and the computer program code may be configured to, with the at least one processor, cause the apparatus at least to determine whether to increase or decrease loading based on the received at least one of predicted performance indicator or performance indicator trend information.

In a variation, the at least one network procedure may comprise a base station (for example an eNode B) performing at least one of blocking more new calls when additional loading from neighboring cells may be anticipated; reactivating more small cells, which were previously deactivated; or initiating more customer/application techniques suggesting greater application usage in regions based on regional performance indicators.

In a variation, the at least one network procedure may comprise an operation and maintenance system performing at least one of reactivating more small cells, which were previously deactivated; triggering server based application optimization techniques to increase or decrease loading; or initiating more customer/application techniques suggesting greater application usage in regions based on regional performance indicators.

In a variation, the predicted performance indicator may be a predicted key performance indicator and the performance indicator trend information may be a key performance indicator trend information.

The above variations may be combined with one another or taken individually.

According to a fifth embodiment, an apparatus may comprise generating means for generating at least one of a predicted performance indicator or a performance indicator trend information at a first network element. The apparatus may also comprise sending means for sending the at least one of predicted performance indicator or performance indicator trend information from the first network element to the second network element.

In a variation, one of the first network element and the second network element may comprise an operation and maintenance system.

In a variation, the operation and maintenance system may comprise a self-organizing network (SON) server.

In a variation, one of the first network element and the second network element may comprise a radio access network element.

In a variation, one of the first network element and the second network element may comprise a core network element.

In a variation, the sending means may further be for sending a confidence metric with the at least one of predicted performance indicator or performance indicator trend information.

In a variation, the confidence metric may comprise at least one of a numeric value or a percentile range of performance indicator.

In a variation, the apparatus may further comprise selecting means for selecting a time interval for the performance indicator trend information based on a time between explicit performance indicator reports.

In a variation, the predicted performance indicator may be a predicted key performance indicator and the performance indicator trend information may be a key performance indicator trend information.

In a variation, the predicted performance indicator may be a performance measurement or performance counter

In a variation, the performance indicator trend information may be a performance measurement trend information or performance counter trend information.

The above variations may be combined with one another or taken individually.

According to a sixth embodiment, an apparatus may comprise receiving means for receiving at least one of a predicted performance indicator or a performance indicator trend information at a second network element from a first network element. The apparatus may also comprise processing means for performing, at the second network element, at least one network procedure based on the received at least one of predicted performance indicator or performance indicator trend information.

In a variation, one of the first network element and the second network element may comprise an operation and maintenance system.

In a variation, the operation and maintenance system may comprise a self-organizing network (SON) server.

In a variation, one of the first network element and the second network element may comprise a radio access network element.

In a variation, one of the first network element and the second network element may comprise a core network element.

In a variation, the receiving means may further be for receiving a confidence metric with the at least one of predicted performance indicator or performance indicator trend information.

In a variation, the confidence metric may comprise at least one of a numeric value or a percentile range of performance indicator.

In a variation, the apparatus may further comprise determining means for determining whether to increase or decrease loading based on the received at least one of predicted performance indicator or performance indicator trend information.

In a variation, the at least one network procedure may comprise a base station (for example an eNode B) performing at least one of blocking more new calls when additional loading from neighboring cells may be anticipated; reactivating more small cells, which were previously deactivated; or initiating more customer/application techniques suggesting greater application usage in regions based on regional performance indicators.

In a variation, the at least one network procedure may comprise an operation and maintenance system performing at least one of reactivating more small cells, which were previously deactivated; triggering server based application optimization techniques to increase or decrease loading; or initiating more customer/application techniques suggesting greater application usage in regions based on regional performance indicators.

In a variation, the predicted performance indicator may be a predicted key performance indicator and the performance indicator trend information may be a key performance indicator trend information.

The above variations may be combined with one another or taken individually.

According to a seventh embodiment, a system may comprise a first apparatus comprising generating means for generating at least one of a predicted performance indicator or a performance indicator trend information at a first network element and sending means for sending the at least one of predicted performance indicator or performance indicator trend information from the first network element to the second network element. The system may also comprise a second apparatus comprising receiving means for receiving the at least one of predicted performance indicator or performance indicator trend information at the second network element from the first network element and processing means for performing, at the second network element, at least one network procedure based on the received at least one of predicted performance indicator or performance indicator trend information.

The variations of the first and second embodiments may be applied to the seventh embodiment, either individually or in combination with one another.

According to eighth and ninth embodiments, a non-transitory computer readable medium may be encoded with instructions that, when executed in hardware, perform a process, the process comprising the method according to respectively the first and second embodiments in any of their variations.

According to tenth and eleventh embodiments, a computer program product, may comprise instructions to perform a process, the process comprising the method according to respectively the first and second embodiments in any of their variations.

According to twelfth and thirteenth embodiments, a computer program, may comprise code for performing the method according to respectively the first and second embodiments in any of their variations.

### BRIEF DESCRIPTION OF THE DRAWINGS

For proper understanding of the invention, reference should be made to the accompanying drawings, wherein:

FIG. 1 illustrates a method according to certain embodiments.

FIG. 2 illustrates another method according to certain embodiments.

FIG. 3 illustrates a system according to certain embodiments.

FIG. 4 illustrates another system according to certain embodiments.

### DETAILED DESCRIPTION

Certain embodiments may permit operation and maintenance (O&M) signaling to transmit to a network element (for example a base station like an evolved node B (eNB) or an access point) an indication of an anticipated value of a performance indicator (for example a key performance indicator (KPI)). Thus, in certain embodiments, it may be possible for the prediction made at one location to be conveyed to another location. For example, certain embodiments address an O&M link from a network element (for example, a eNB) up to the centralized O&M, with respect to existing KPIs.

In the description, various performances indicators are mentioned. A key performance indicator is one example of a performance indicator, but other examples may include a performance management (PM) counter, a PM measurement, or the like. Moreover, a predicted performance indicator, for example KPI, can be communicated from an O&M system to a network element as a configuration attribute, such as configuration management (CM) attribute or CM parameter, and in the opposite direction from NE to O&M system as a configuration attribute value change or a corresponding notification.

In the description an O&M system is just an example of an entity offering control and/or performance management functions for connected network elements, and a base station (for example, a eNB) or an access point are just examples for a network element connected to the O&M network element/system. The invention is not limited to the mentioned network elements/system and may be applied to any kind of network elements/system.

In certain embodiments, a method may enable communication of long term evolution (LTE) performance indicator prediction between an evolved node B and an operation and maintenance system. Rather than having metrics that are merely historical, certain embodiments may relate to cases in which the eNB may indicate not only the current value of a performance indicator but also the eNB's anticipated future value, and to cases in which the centralized O&M may indicate to the eNB the O&M's anticipated future, or predicted, value of a performance indicator that the eNB is reporting.

Thus, for example, in certain embodiments the eNB may indicate not only a current value of performance indicator but also an anticipated, or predicted, future value of performance indicator for the eNB. The current value and the future value may be reported together or separately from one another. In certain embodiments, only future values may be reported.

The method by which an eNB calculates the anticipated/future value may vary. For example, the eNB may calculate the anticipated/future value based on a short-term trend observed on the performance indicator by the eNB. For instance, the short term may be over the last 5 minutes, and the time since the last explicit performance indicator report was made may be greater than 5 minutes, such as, for example, 30 minutes.

Various network elements, such as for example an O&M system, may be enabled to better estimate a current value of the performance indicator as time passes subsequent to the last explicit performance indicator report. Alternatively, a core network element may be enabled to estimate a current value of the performance indicator as time passes subsequent to the last explicit performance indicator report. Uses for this information within the network may comprise numerous use cases, of which the following are just a few examples: application prefilling video behavior modification based on eNB utilization performance indicators; prefetching of other objects, not just video prefill; selection of media object duration based on cell loading; and selection of gaming difficulty based on cell loading.

Various network elements may be provided in an operation and management system. For example, a centralized self-organizing network (C-SON) server may be one operation and management system device.

In four example use cases, mechanisms for utilizing otherwise unused wireless resources are mentioned. One unifying theme across these is improved capacity and user experience by allowing prefilling/prefetching when there is less loading in a wireless system. In general, however, these cases may not generate as much benefit if they are leveraging an inaccurate current estimate of the performance indicator value.

For example, without performance indicator prediction, during the time interval when the system becomes less loaded, and an application server/optimizer/browsing gateway may still believe that the system is overloaded, and the application server/optimizer/browsing gateway may miss the opportunity to perform prefilling, exploiting the unutilized physical resources. Moreover, during the time interval when the system becomes more loaded, and the application server/optimizer/browsing gateway may still believe the system is underloaded. Thus, prefilling video users may consume extra system capacity which otherwise would not be used on prefilling.

As mentioned above, in certain embodiments, a centralized O&M system may indicate to the eNB the centralized O&M's estimate of the future value of a performance indicator that the eNB is reporting. In one example use case, such an embodiment may enable the eNB to perform admission control decisions based on anticipated loading changes predicted by the centralized O&M system. The admission control, for example, may decide whether or not to admit a new call or guaranteed bit rate request, for example, for video.

For example, the centralized system may use longer-term data mining, of loading across the system to anticipate loading or other performance indicators at a particular eNB. This may then enable the eNB to anticipate when the eNB loading will likely be increasing or decreasing over the next time interval. In the case where the centralized system anticipates that the loading will be increasing over the next time interval, the eNB may, for example, block a larger fraction of the higher bit rate guaranteed bit rate (GBR) service requests.

In a multivendor environment, where the eNB is from one vendor and the O&M system, above an Itf-N interface, is from a different vendor, a proprietary or non-standard mechanism for providing a performance indicator prediction down to the eNB, or up from the eNB may be incompatible with another vendor's proprietary interface agreement. Certain embodiments, therefore, may provide a mechanism for providing performance indicator predictions down to the eNB from the centralized O&M system, which may thereby enable multivendor use cases.

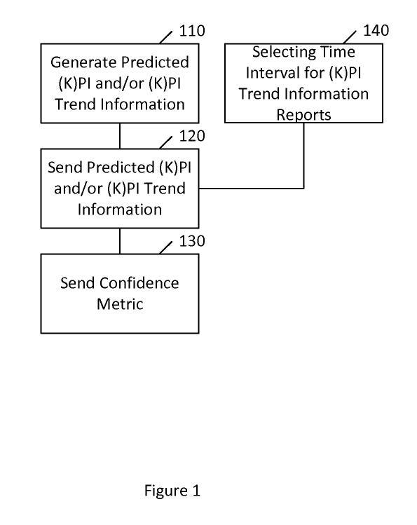

FIG. 1 illustrates a method according to certain embodiments. As shown in FIG. 1, a method may comprise, at 110, generating at least one of a predicted performance indicator (for example, a KPI) or a performance indicator (for example, KPI) trend information at a first network element. In other words, either a predicted (key) performance indicator may be generated or a (key) performance indicator trend information may be generated or both may be generated. The predicted (key) performance indicator may be an expected value for a (key) performance indicator. It may be an indicator relevant to the device itself, which is generating the prediction, or it may be an indicator relevant to another device. Optionally, both an own prediction and a prediction of another device's value may be provided. Likewise, the (key) performance indicator trend information may be information regarding a trend of a (key) performance indicator value for the device generating the trend information or it may be regarding another device's (key) performance indicator value trend. The term “(key) performance indicator” or “(K)PI” can refer to any performance indicator, with a key performance indicator being one illustrative example.

The method may also comprise, at 120, sending the at least one of predicted (key) performance indicator or (key) performance indicator trend information from the first network element to the second network element. The sending may comprise sending over a link between for example an eNode B and an operation and maintenance system. More specifically the sending may comprise signaling from the eNode B to the operation and maintenance system. Alternatively, the sending may comprise signaling from the operation and maintenance system to the eNode B. Thus, for example, each of the operation and maintenance system and the eNode B may be either the first network element or the second network element. For example, the eNode B may generate and send its own predicted (key) performance indicator or an operation and maintenance system may generate and send a predicted (key) performance indicator of the eNode B. Of course, the (key) performance indicators of other system elements may be predicted or the trend information of such other elements may be identified, with the eNode B and the operation and maintenance system being merely two examples of network elements.

In other words, certain embodiments may involve the communication of at least one of future (key) performance indicator ((K)PI) predictions and (K)PI trend information over an operations and maintenance link between the eNB to the O&M. This communication may comprise at least one of signaling from the eNB to the O&M, for example, from IRPAgent to IRPManager over Itf-N in SA5 terms, or signaling from the O&M to the eNB, for example, from IRPManager to IRPAgent over Itf-N in 3GPP SA5 terms. The signaling may specifically be an indication of the predicted (K)PI value

The method may further comprise, at 130, sending a confidence metric with the at least one of predicted (key) performance indicator or (key) performance indicator trend information. The confidence metric may comprise at least one of a numeric value or a percentile range of (key) performance indicator. For example, the confidence metric may be a value between zero and ten, where zero is extremely low confidence and ten is certainty or near certainty. Alternatively, the confidence metric may indicate a percentile range of (K)PI, such as the value(s) expected to bound the actual (K)PI in the time interval. Other confidence metric approaches may also be used, such as for example an amount of a standard deviation value.

The method may additionally comprise, at 140, selecting a time interval for the (key) performance indicator trend information based on a time between explicit (key) performance indicator reports. For example, for a trend (K)PI, the transmitting entity may indicate the trend observed over the last time interval. The time interval may be longer when the time between explicit reporting over operations and maintenance is configured to be longer. For example, a short-term trend observed on the (K)PI by the eNB over the last five minutes may be selected where the time since the last explicit (K)PI report was greater than five minutes, such as thirty minutes.

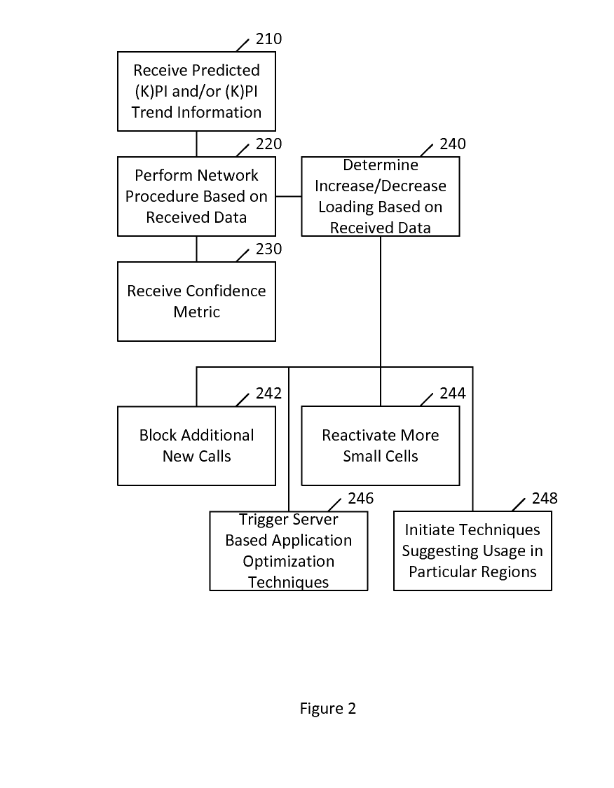

FIG. 2 illustrates another method according to certain embodiments. As shown in FIG. 2, a method may comprise, at 210, receiving and processing at least one of a predicted (key) performance indicator or a (key) performance indicator trend information at a second network element from a first network element. As mentioned above, a “(key) performance indicator,” can be any kind of performance indicator, with a key performance indicator being one example. The predicted (key) performance indicator and the (key) performance indicator trend information may be as described above with reference to FIG. 1. Indeed, the methods of FIG. 1 and FIG. 2 may be used together. Thus, both a (key) performance indicator trend information and a predicted (key) performance indicator may be received or only one of them may be received. Moreover, as mentioned above, the first and second network elements may be either of a eNode B and an operation and maintenance system, as examples of possible network elements.

As shown in FIG. 2, the method may also comprise, at 220, performing, at the second network element, at least one network procedure based on the received at least one of predicted (key) performance indicator or (key) performance indicator trend information. The method may further comprise, at 230, receiving a confidence metric with the at least one of predicted (key) performance indicator or (key) performance indicator trend information. The confidence metric may comprise at least one of a numeric value or a percentile range of key performance indicator.

The method may additionally comprise, at 240, determining whether to increase or decrease loading based on the received at least one of predicted (key) performance indicator or (key) performance indicator trend information. This determining may be performed at the second network element. For example, the at least one network procedure may comprise at least one of, at 242, blocking more new calls when additional loading from neighboring cells is anticipated; reactivating, at 244, more small cells, which were previously deactivated; at 246, triggering server based application optimization techniques to increase or decrease loading; or initiating, at 248, more customer experience management/application techniques suggesting users travel through regions based on regional (key) performance indicators. The above listed network procedures are just examples and are not limiting.

More specifically, when (K)PI prediction signaling is from O&M to the eNB, the eNB may respond to a (K)PI indicating increasing trend of loading by blocking more, for example higher bit rate, new calls when additional loading from neighboring cells is anticipated based on signaling from the network or the eNB may respond by for example reactivating more small cells, which were previously deactivated in order to conserve energy.

In another example, when (K)PI prediction signaling is from eNB to O&M, the O&M may respond to this knowledge of decreasing loading indicated by (K)PI, by triggering server based application optimization techniques. The server based application optimization technique may comprise, for example, techniques resulting in additional prefetching more prefilling of various media objects, in order to more fully utilize otherwise unused or underutilized wireless resources. For example, the techniques may comprise social networking pre-fetch additional friend updates/postings during intervals of lower loading, news applications may pre-fetch additional articles during intervals of lower loading, video players may pre-fetch additional content before it is needed during intervals of lower loading, e-mail readers may pre-fetch additional e-mail contents farther in advance before they are needed, or web browsers may pre-fetch additional content for links in a most recent HTML search result, before the user actually clicks on one of search results. Other techniques may comprise increasing the total time till the media watching is completed, for example, providing the longer version of that media, decreasing the difficulty within wireless gaming applications completes when the user dies. Another example technique is increasing the length of the course within a car racing gaming application. Other techniques may comprise initiating more customer experience management (CEM)/application techniques suggesting users travel through regions with good (K)PIs, and avoid geographic areas with worse (K)PIs. For example, vehicle navigation systems may take into account the anticipated congestion levels and alter the route selected for the vehicle navigation system. This may be performed similar to the way in which vehicle traffic congestion is incorporated into a vehicle routing system.

In another example, when (K)PI prediction signaling is from eNB to O&M, the O&M may respond to an estimate of increasing loading, which may be provided as a (K)PI, by triggering less loading, for example, prefetching. For examples, here consider the opposite of the examples listed above.

The methods of FIG. 1 and FIG. 2 may be used together. Moreover, the predicted performance indicator or trend information may be exchanged in various ways between any two network elements. The participants may include, among other network elements, an operation and maintenance system, a core network element, and a radio access network element. For example, the exchange may be between an access network element and a core network element or between an access network element and an operation and maintenance system or in general between any two network elements.

Four major use cases may illustrate various possible implementations according to certain embodiments. First, there may be use cases where the prediction (K)PIs may be sent from the eNB to the centralized O&M.

In each of these four use cases there may be mechanisms for utilizing otherwise unused or underutilized wireless resources. A unifying theme across these cases may be that these approaches improve capacity and user experience by allowing prefilling/prefetching when there is less loading in wireless system.

In a first use case, application prefilling video behavior modification may be based on eNB utilization (K)PIs. Conventionally, a video player may prefill by downloading video beyond what is need for just in time playing. For example, a video player may buffer several minutes of video in advance of what is needed. This approach may waste capacity if the user equipment abandons the video without watching the prefilled portion. Moreover, many videos are abandoned prior to being completely watched. On the other hand, conventionally, a media optimizer or browsing gateway may always prevent prefilling, which may hurt a quality of experience (QoE) in some cases, because it may result in video delays.

Another approach may be to detect user download speed, for example by monitoring a transmission control protocol (TCP) acknowledgment (ACK) rate. For example, a first portion of the video may be streamed to a compressed minimum bit rate and a second section may be compressed to an adapted bit rate, based on monitoring the first portion. Thus, a browsing gateway may provide video content with a bit rate matching a link speed estimate, using transcoding, transrating, and/or media selection. Such an approach may avoid video delay in a lower bandwidth pipe.

However, in accordance with certain embodiments, eNB resources that are currently unused may be used for prefilling. Moreover, users of pre-filled video may stop prefilling when a loading spike occurs and may, due to the pre-filled video data, continue to play the video when there is a loading spike or loss of coverage. Thus, a user may have an improved user experience and an actually higher data user rate. Furthermore, this approach may minimize user awareness of video coverage gaps. Additionally, this may permit the user to fast-forward within a video more quickly, as the user can immediately move forward to another section of the movie and begin play out, if media for those other future sections have already been prefilled. Other benefits may also exist. For example, if operator revenue is based on used data, the use of more data may result in higher revenue. Moreover, the use of adaptive prefilling may be offered as a premium service in itself.

Additionally, because pre-filling may be tied to the usage of eNB resources, prefilling of video may be limited to cases where eNB resources are underutilized. Thus, undue burden on eNB resources may be avoided.

In a second use case, there may be prefetching of other objects, not just video prefill. Non limiting examples here may comprise prefetching of various media objects, in order to more fully utilize otherwise unused or underutilized wireless resources. For example, a social networking application may prefetch additional friend updates/postings during intervals of lower living, a news application may prefetch additional articles during intervals of lower loading, a video player may prefetch additional content before it is needed during intervals of lower loading, an e-mail reader may prefetch additional e-mail contents farther in advance before they are needed, or a web browsers may prefetch additional content for links in a most recent hypertext markup language (HTML) search result, before the user actually clicks on one of search results.

In this case, the server, or customer experience management (CEM) system may be coupled with certain application servers triggering them to perform additional prefetching of these objects in order to improve customer experience by reducing latency when the user launches these applications. This triggering of prefetching may also be in order to further load balance the system by prefetching more content in the background when loading is lower, thereby avoiding some fraction of the content in the most loaded cells at the most loaded times.

In a third use case, selection of media object duration may be made based on cell loading. In this use case, the application server may preferentially provide a longer version of media/video being requested, in response to detecting that cell loading (K)PI is lower. For example, there may be a shorter or longer version of the daily news.

In a fourth use case selection of gaming difficulty may be based on cell loading. In this use case, the gaming server may decrease the difficulty within wireless gaming applications, thereby increasing the duration of the game and the amount of time until user's gaming character dies in the game. In the case where the cell loading is greater, then the duration may be decreased. This may assume that the game requires data transfer during usage. If, instead, the games generally transfers data upon loading a new level, the difficulty of getting to a new level may be increased when network resources are more heavily utilized, and made may be decreased when network resources are more plentiful.

There may also be customer experience management use cases. One use case is one in which the system may attempt to estimate/detect the case where an eNB is overloaded and is anticipated to stay overloaded for the next two hours. At this point, a third party campaign piece of software used by the core network may trigger messaging to the end user indicating that this overload is expected to persist in this particular eNB, and offering to provide higher priority/better throughput to this particular user if the user is willing to pay an additional sum, use credits, watch an advertisement, or the like. This specific CEM use case may be targeted at the case where users are typically prepaid. At least three other CEM use cases may comprise bridging CEM and video, prefilling and social networking, as discussed in part above.

In the four use cases above, mechanisms for, among other things, utilizing otherwise unused or underutilized wireless resources have been described. A unifying theme across these is improved capacity and user experience by allowing prefilling/prefetching when less loading in wireless system.

However, during the time interval when the system becomes less loaded, and the application server/optimizer/browsing gateway still believes the system is overloaded, the application server/browsing gateway may have missed the opportunity to perform prefilling exploiting the unutilized physical resource blocks. During the time interval when the system becomes more loaded, and the application server/browsing gateway still believes the system is underloaded, prefilling video users may consume extra system capacity which otherwise would not be used for prefilling. Thus, more frequent KPI reporting may be used.

However, conventionally, O&M metrics are historical, reporting on past events. Additionally, more frequent (K)PI reporting may introduce significant messaging, especially for small cells.

If an example is taken where the estimated value for the (K)PI needs to be more accurate than once every 30 minutes, if instantaneous (K)PI reports are employed, there may be 4 reports, where each report may have a size=1 KB. Thus, the reporting frequency may need to be configured to be once every 15 minutes, wherein each report may be one kilobyte. By contrast if (K)PI prediction/trend reports are used, there may be 2 reports, with each report being 1 KB+0.2 kB. The 0.2 KB may convey the additional trend or prediction information. Of course, both trend and prediction information may be simultaneously transmitted. In this example, half as many reports may be required because at the time of each report a trend or prediction may also be reported enabling the O&M, and therefore application server, to better estimate the cell loading during the time interval between consecutive reports. Thus, the reporting interval may be lengthened to 30 minutes.

In this example, the total amount of messaging load is reduced by 1.67×, or 60%, from ˜(4*1 KB) to 2*1.2 KB; 1.66=4/2.4.

There also may be eNB prediction use cases. Example use case scenarios may exist in which eNB may have unique insights into its anticipated congestion level, for example based on mobility patterns within the cell, with users moving within the cell, or trends in the amount of traffic being carried. It may be appropriate to enable the eNB to use implementation dependent mechanisms to estimate the future loading over different time intervals in the eNB. Furthermore, it may be appropriate to enable the eNB to indicate its confidence level and its estimate. For example, some eNBs may have more sophisticated approaches to predicting or may have larger data sets on which to base their estimate, leading to a higher level of confidence.

In cases in which the prediction (K)PIs are being from the O&M to the centralized eNB, conventionally it may not be possible for the prediction generated at a centralized O&M to be conveyed over a standardized interface to the eNB. However, in one use case according to certain embodiments, the eNB may perform admission control decisions based on anticipated loading changes predicted by the centralized O&M system. For example, the centralized system may use longer-term data mining of loading across the system to anticipate loading or other (K)PIs at a particular eNB. This may then enable the eNB to anticipate when the eNB loading will likely be increasing or decreasing over the next time interval. In the case where the centralized system anticipates that the loading will be increasing for the next time, the eNB may for example block a larger fraction of the higher bit rate GBR service requests.

In a multivendor environment, where the eNB is from one vendor and the O&M system (above, for example, standardized Itf-N) is from a different vendor, a potential proprietary mechanism for providing a (K)PI prediction down to the eNB may potentially be incompatible with other vendors proprietary interface agreement. According to certain embodiments, a standardized mechanism for providing (K)PI predictions down to the eNB from the centralized O&M system may be provided.

O&M prediction use cases may also exist. The centralized O&M system may have further insights into the anticipated congestion level at an eNB. These insights may be based, for example, on long-term trending analysis, based on mobility patterns such as large group of users moving towards a particular unity. This may occur in the case of a gathering demonstration, concert, rally, meal time, or work schedule. For example, mobile service in a restaurant area may have higher loading around a meal time, and mobile service in a financial district of a city may have higher loading during business hours.

Predictions may be performed at the centralized operations and maintenance, and/or at the eNB. However, in the multivendor environment it is not conventionally possible for the prediction one location to be conveyed to the other location. One way of providing a prediction is to provide a measured trend over a previous time interval. This may apply to the coverage capacity optimization use case, and a variety of other cases.

An energy savings use case may also exist. Reactivating more small cells, which were previously deactivated in order to conserve energy, may be performed. For example, the eNB or O&M may responds to a (K)PI indicating increasing trend of loading by reactivating more small cells, which were previously deactivated in order to conserve energy.

Thus, in certain embodiments an eNB may be reporting its predicted/anticipated value for specific (K)PIs, including but not limited to physical resource block (PRB) utilization at the eNB. Moreover, application optimization entities residing within the network then leveraging these (K)PI predictions to better estimate changes in PRB utilization over time, thereby may drive application optimizations based this improved estimate of the (K)PI, leveraging the eNB's prediction.

Moreover, ENB admission control may leverage input received from O&M on predicted upcoming changes in that eNB's PRB utilization/loading over the next time interval. For example, if O&M predicts that the utilization will go up over the next time interval, then admission control may block a greater fraction of higher bit rate incoming GBR/call requests.

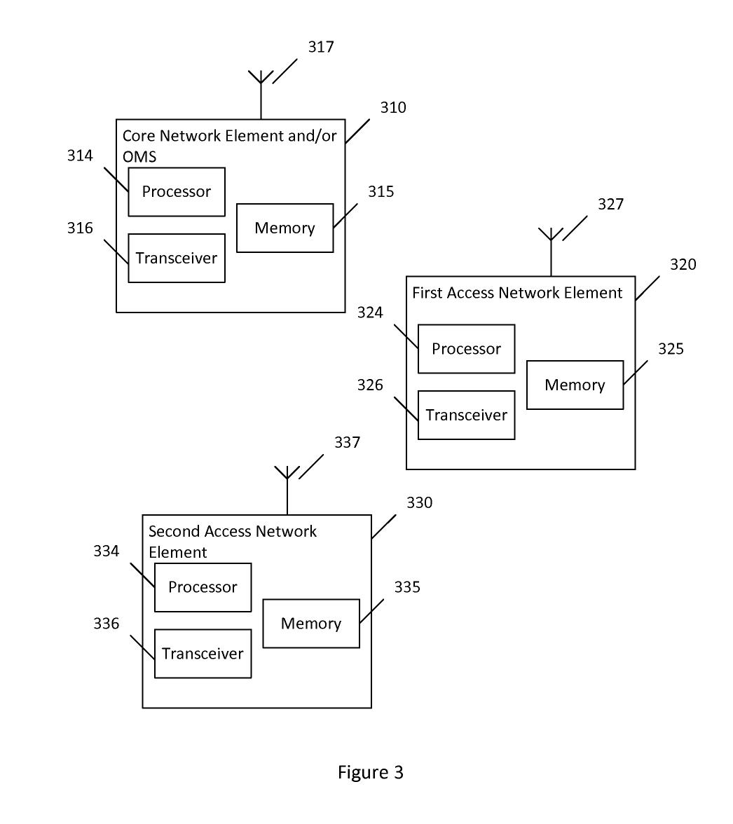

FIG. 3 illustrates a system according to certain embodiments of the invention. In one embodiment, a system may comprise several devices, such as, for example, network element 310, first access network element 320, and second access network element 330. The system may comprise more than two access network elements and more than one other network element, although only one other network element and two access network elements are shown for the purposes of illustration. The network element 310 may be an O&M system and/or an application server. Alternatively, the network element 310 may be a core network element. The first access network element 320 and/or the second access network element 330 may be a base station, such as an evolved Node B, or an access point.

Each of the devices in the system may comprise at least one processor, respectively indicated as 314, 324, and 334. At least one memory may be provided in each device, and indicated as 315, 325, and 335, respectively. The memory may comprise computer program instructions or computer code contained therein. One or more transceiver 316, 326, and 336 may be provided, and each device may also comprise an antenna, respectively illustrated as 317, 327, and 337. Although only one antenna each is shown, many antennas and multiple antenna elements may be provided to each of the devices. Other configurations of these devices, for example, may be provided. For example, network element 310 and first/second access network element 320/330 may be additionally or solely configured for wired communication, and in such a case antennas 317, 327, and 337 may illustrate any form of communication hardware, without being limited to merely an antenna.

Transceivers 316, 326, and 336 may each, independently, be a transmitter, a receiver, or both a transmitter and a receiver, or a unit or device that may be configured both for transmission and reception.

Processors 314, 324, and 334 may be embodied by any computational or data processing device, such as a central processing unit (CPU), application specific integrated circuit (ASIC), or comparable device. The processors may be implemented as a single controller, or a plurality of controllers or processors.

Memories 315, 325, and 335 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors may be any suitable form of computer program code, for example, a compiled or interpreted computer program written in any suitable programming language.

The memory and the computer program instructions may be configured, with the processor for the particular device, to cause a hardware apparatus such as network element 310, first access network element 320, and second access network element 330, to perform any of the processes described above (see, for example, FIGS. 1-2). Therefore, in certain embodiments, a non-transitory computer-readable medium may be encoded with computer instructions that, when executed in hardware, may perform a process such as one of the processes described herein. Alternatively, certain embodiments of the invention may be performed entirely in hardware.

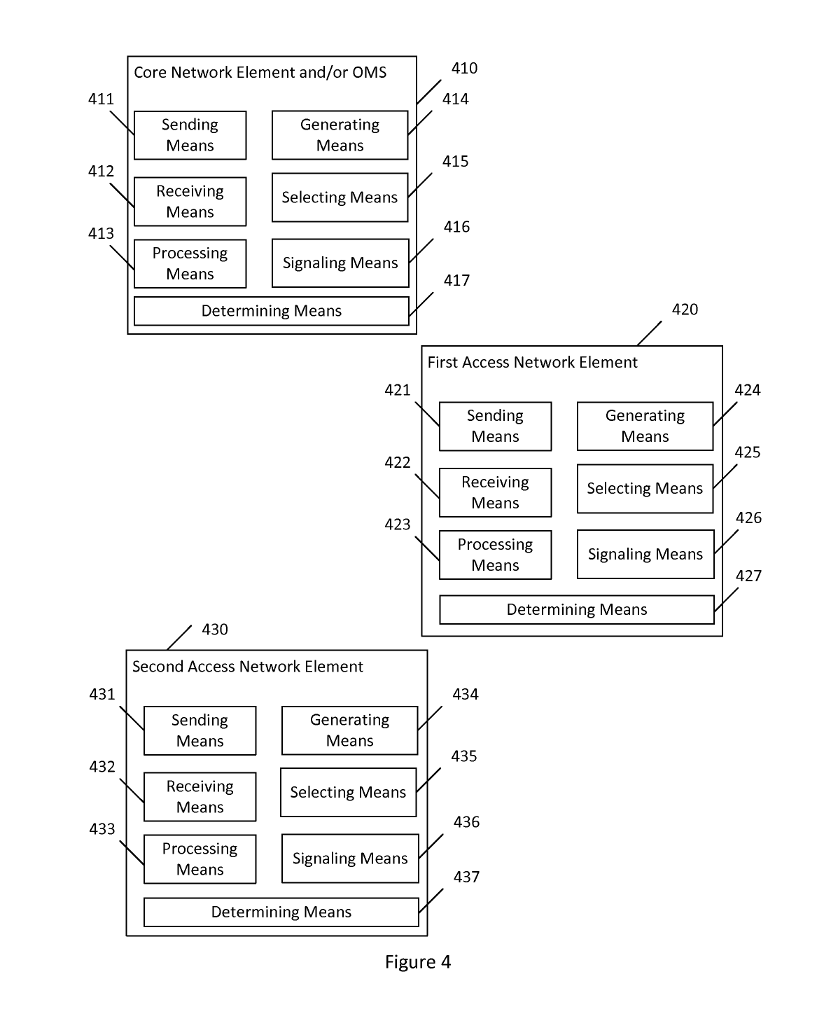

FIG. 4 illustrates a system according to certain embodiments. The system of FIG. 4 may be similar to the system of FIG. 3, in that it may comprise at least one network element 410 and at least two access network elements: a first access network element 420 and a second access network element 430. It is not necessary that the system include two such access network elements, and the first access network element 420 and the second access network element 430 may be located in different geographic regions or adjacent to one another (the same applies to the access network elements 320/330 shown in FIG. 3). Moreover, the first access network element 420 and the second access network element 430 may be operated by different vendors from one another and from the vendor that operates the network element 410.

The network element 410 may comprise sending means 411, receiving means 412, and processing means 413, for carrying out any of the above-described methods. The processing means 413 may more particularly be for performing at least one network procedure based on a received predicted (key) performance indicator and/or a received (key) performance indicator trend information and/or received related confidence metric and for determining whether for example to increase or decrease loading based on the received at least one of predicted (key) performance indicator or (key) performance indicator trend information.

The network element 410 may also comprise generating means 414 for generating at least one of a predicted (key) performance indicator or a (key) performance indicator trend information, and optionally generating related confidence metrics. The network element 410 may also comprise selecting means 415 for selecting a time interval for the (key) performance indicator trend information.

The network element 410 may further comprise signaling means 416 for signaling from an operation and maintenance system to the eNode B.

The network element 410 may further comprise determining means 417 for determining whether to increase or decrease loading based on the received at least one of predicted performance indicator or performance indicator trend information.

The first access network element 420 may be a radio access network element, such as for example a base station or an access point. The first access network element 420 may, like the network element 410, comprise sending means 421, receiving means 422, and processing means 423, for carrying out any of the above-described methods. The processing means 423 may more particularly be for performing at least one network procedure based on a received predicted (key) performance indicator and/or a received (key) performance indicator trend information and/or an optionally received related confidence metric, and for determining for example whether to increase or decrease loading based on the received at least one of predicted (key) performance indicator or (key) performance indicator trend information taking the optionally received confidence metric into account.

Moreover, the first access network element 420 may comprise generating means 424 for generating at least one of a predicted (key) performance indicator or a (key) performance indicator trend information and optionally a related confidence metric.

The first access network element 420 may comprise selecting means 425 for selecting a time interval for the (key) performance indicator trend information. The first access network element 420 may further comprise signaling means 426 for signaling from the eNode B to the operation and maintenance system.

The first access network element 420 may further comprise determining means 427 for determining whether to increase or decrease loading based on the received at least one of predicted performance indicator or performance indicator trend information.

The second access network element 430 may be a radio access network element, such as for example another base station or another access point. It is not necessary that the first access network element 420 and the second access network element 430 employ the same radio access technology (RAT). Indeed, while the discussion above has addressed eNBs as examples, other network elements such as a relay node may serve as the second access network element 430. The second access network element 430 may, like the network element 410, comprise sending means 431, receiving means 432, and processing means 433, for carrying out any of the above-described methods. The processing means 433 may more particularly be for performing at least one network procedure based on a received predicted (key) performance indicator and/or a received (key) performance indicator trend information and/or the optionally received related confidence metric and for determining for example whether to increase or decrease loading based on the received at least one of predicted (key) performance indicator or (key) performance indicator trend information and optionally a related confidence metric.

The second access network element 430 may also comprise generating means 434 for generating at least one of a predicted (key) performance indicator or a (key) performance indicator trend information, and optionally generating related confidence metrics. Additionally, the second access network element 430 may comprise selecting means 435 for selecting a time interval for the (key) performance indicator trend information.

Moreover, the second access network element 430 may comprise signaling means 436 for signaling from the eNode B to the operation and maintenance system.

The second access network element 430 may further comprise determining means 437 for determining whether to increase or decrease loading based on the received at least one of predicted performance indicator or performance indicator trend information.

Various modifications to certain embodiments are possible. Certain principles of the various embodiments may also be variously applied and may be applied in combination with other techniques. For example, the transmission time of a file may be reduced by using file compression. However, in a Heterogeneous Network (HetNet) scenario the number of individual transmissions may be very high and reducing the frequency of transmissions may be valuable. If longer reporting intervals are used, for example once in an hour instead of once in 5 minutes, the accuracy and usefulness of the reporting data for the real time analysis above Itf-N may be lost. Certain embodiments provide an approach in which there is reduced frequency of reporting while informing about the predicted trend of the reported data.

(Key) performance indicators may be variously reported. In certain embodiments, for particular counters of these indicators the prediction may be better or more accurate at the network element (NE), for example eNB, level since many of the configuration parameters and process implementation details may be proprietary and not known/exposed above the Itf-N. However, a generic (K)PI or counter wrapper can be defined to wrap around existing (K)PIs/counters. This wrapper may then be selectively enabled or allowed for specific (K)PIs/counters.

The utility of predictive downflow and upflow messaging according to certain embodiments need not be specific to self-organizing networks (SON). This more general (K)PI/counter solution may enable a number of reactions to the downflow and upflow messaging. Moreover, while (K)PI prediction is discussed herein, this should be understood broadly to include prediction of not only calculated (K)PIs but also of the standardized or specifically designed performance management (PM) counters. The configuration management (CM) flow down from network management system (NMS) to network element (NE) and PM flow up from NE to NMS may provide another description of certain embodiments.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### GLOSSARY

ES Energy Savings

CEM Customer Experience Management

HetNet Heterogeneous Network

We claim:

1. A method, comprising:
generating at least one of a predicted performance indicator or a performance indicator trend information at a first network element; and
sending the at least one of predicted performance indicator or performance indicator trend information from the first network element to the second network element.

2. The method of claim 1, further comprising:
sending a confidence metric with the at least one of predicted performance indicator or performance indicator trend information.

3. The method of claim 1, further comprising:
selecting a time interval for the performance indicator trend information based on a time between explicit performance indicator reports.

4. The method of claim 1, wherein the predicted performance indicator is a predicted key performance indicator, and
wherein the performance indicator trend information is a key performance indicator trend information.

5. The method of claim 1, wherein the predicted performance indicator is a performance measurement or performance counter, and
wherein the performance indicator trend information is a performance measurement trend information or performance counter trend information.

6. A method, comprising:
receiving at least one of a predicted performance indicator or a performance indicator trend information at a second network element from a first network element; and
performing, at the second network element, at least one network procedure based on the received at least one of predicted performance indicator or performance indicator trend information.

7. The method of claim 6, further comprising:
receiving a confidence metric with the at least one of predicted performance indicator or performance indicator trend information.

8. The method of claim 6, further comprising:
determining whether to increase or decrease loading based on the received at least one of predicted performance indicator or performance indicator trend information.

9. The method of claim 6, wherein the at least one network procedure comprises an base station performing at least one of
blocking more new calls when additional loading from neighboring cells is anticipated;
reactivating more small cells, which were previously deactivated; or
initiating more customer/application techniques suggesting greater application usage in regions based on regional performance indicators.

10. The method of claim 6, wherein the at least one network procedure comprises an operation and maintenance system performing at least one of
reactivating more small cells, which were previously deactivated;
triggering server based application optimization techniques to increase or decrease loading; or
initiating more customer/application techniques suggesting greater application usage in regions based on regional performance indicators.

11. The method of claim 6, wherein the predicted performance indicator is a predicted key performance indicator and the performance indicator trend information is a key performance indicator trend information.

12. An apparatus, comprising:
at least one processor; and
at least one memory including computer program code,
wherein the at least one memory and the computer program code are configured to, with the at least one processor, cause the apparatus at least to
generate at least one of a predicted performance indicator or a performance indicator trend information at a first network element; and
send the at least one of predicted performance indicator or performance indicator trend information from the first network element to the second network element.

13. The apparatus of claim 12, wherein one of the first network element and the second network element comprises an operation and maintenance system.

14. The apparatus of claim 13, wherein the operation and maintenance system comprises a self-organizing network (SON) server.

15. The apparatus of claim 12, wherein one of the first network element and the second network element comprises a radio access network element.

16. The apparatus of claim 12, wherein one of the first network element and the second network element comprises a core network element.

17. The apparatus of claim 12, wherein the at least one memory and the computer program code are further configured to, with the at least one processor, cause the apparatus at least to send a confidence metric with the at least one of predicted performance indicator or performance indicator trend information.

18. The apparatus of claim 12, wherein the at least one memory and the computer program code are configured to, with the at least one processor, cause the apparatus at least to select a time interval for the performance indicator trend information based on a time between explicit performance indicator reports.

19. The apparatus of claim 12, wherein the predicted performance indicator is a predicted key performance indicator, and
wherein the performance indicator trend information is a key performance indicator trend information.

20. The apparatus of claim 12, wherein the predicted performance indicator is a performance measurement or performance counter, and
wherein the performance indicator trend information is a performance measurement trend information or performance counter trend information.

21. An apparatus, comprising:
at least one processor; and
at least one memory including computer program code,
wherein the at least one memory and the computer program code are configured to, with the at least one processor, cause the apparatus at least to
receive at least one of a predicted performance indicator or a performance indicator trend information at a second network element from a first network element; and
perform, at the second network element, at least one network procedure based on the received at least one of predicted performance indicator or performance indicator trend information.

22. The apparatus of claim 21, wherein one of the first network element and the second network element comprises an operation and maintenance system.

23. The apparatus of claim 22, wherein the operation and maintenance system comprises a self-organizing network (SON) server.

24. The apparatus of claim 21, wherein one of the first network element and the second network element comprises a radio access network element.

25. The apparatus of claim 21, wherein one of the first network element and the second network element comprises a core network element.

26. The apparatus of claim 21, wherein the at least one memory and the computer program code are configured to, with the at least one processor, cause the apparatus at least to receive a confidence metric with the at least one of predicted performance indicator or performance indicator trend information.

27. The apparatus of claim 21, wherein the at least one memory and the computer program code are configured to, with the at least one processor, cause the apparatus at least to determine whether to increase or decrease loading based on the received at least one of predicted performance indicator or performance indicator trend information.

28. The apparatus of claim 21, wherein the at least one network procedure comprises an base station performing at least one of
blocking more new calls when additional loading from neighboring cells is anticipated;
reactivating more small cells, which were previously deactivated; or
initiating more customer/application techniques suggesting greater application usage in regions based on regional performance indicators.

29. The apparatus of claim 21, wherein the at least one network procedure comprises an operation and maintenance system performing at least one of
reactivating more small cells, which were previously deactivated;
triggering server based application optimization techniques to increase or decrease loading; or
initiating more customer/application techniques suggesting greater application usage in regions based on regional performance indicators.

30. The apparatus of claim 21, wherein the predicted performance indicator is a predicted key performance indicator and the performance indicator trend information is a key performance indicator trend information.

31. A non-transitory computer readable medium encoded with instructions that, when executed in hardware, perform a process, the process comprising the method according to claim 1.

32. A non-transitory computer readable medium encoded with instructions that, when executed in hardware, perform a process, the process comprising the method according to claim 6.
